(19) United States
(12) Patent Application Publication
(10) Pub. No.: US 2017/0060922 A1
(43) Pub. Date: Mar. 2, 2017

(54) METHOD AND DEVICE FOR DATA SEARCH

(71) Applicant: Xiaomi Inc., Beijing (CN)

(72) Inventors: Yonghui Zhao, Beijing (CN); Haifeng Li, Beijing (CN); Haibin Weng, Beijing (CN)

(21) Appl. No.: 15/065,861

(22) Filed: Mar. 10, 2016

(30) Foreign Application Priority Data
Aug. 26, 2015 (CN) 201510531673.4

(51) Int. Cl. G06F 17/30

(52) U.S. Cl. CPC G06F 17/30324; G06F 17/30424

(57) ABSTRACT

Method and device for data search are provided. The method includes: retrieving a first serialized data corresponding to a first user identifier in a non-relational database; deserializing the first serialized data to obtain a first index; performing a search based on the first index. In the embodiments of the present disclosure, serialized data corresponding to a user identifier may be retrieved and deserialized into an index by a server in a NoSQL database and a search may be performed based on the index. Since the search is performed against data corresponding to user identifiers rather than all users, a much smaller search scope is covered, leading to an improved search speed and performance and optimized user experience.

### CROSS-REFERENCE TO RELATED APPLICATIONS

This application is based upon and claims priority to Chinese Patent Application No. 201510531673.4, filed Aug. 26, 2015, which is incorporated herein by reference in its entirety.

### TECHNICAL FIELD

The present disclosure generally relates to data processing, and more particularly, to a method, device, and computer-readable medium for data search.

### BACKGROUND

With an ever increasing number of functions of a mobile terminal, more and more data is generated by users using the mobile terminal. Users may synchronize personal data to cloud for storage in order to minimize the memory occupied in the mobile terminal and to avoid performance degradation caused by insufficient storage space. Typically, a cloud server may provide users with a function for retrieving personal data, for example, searching for a message containing a keyword in tens of thousands of messages based on the keyword provided by a user.

In related art, the cloud server may realize a search for personal data based on Structured Query Language (SQL). However, given the poor extensibility of the SQL, particularly when there are a large number of users, there is a huge amount of data stored in the cloud. In this case, the search scope of the server is personnel data of all users, leading to low efficiency, slow speed and poor security for data search, and resulting in poor user experience.

### SUMMARY

In view of the fact in related arts that a search for user data suffers from low efficiency and slow speed, a method, device, and computer-readable medium for data search are provided in the disclosure.

According to a first aspect of the present disclosure, a method for data search is provided. The method includes: retrieving a first serialized data corresponding to a first user identifier in a non-relational database; deserializing the first serialized data to obtain a first index; performing a search based on the first index.

According to a second aspect of embodiments of the present disclosure, a server for data search is provided, including: a processor; and a memory for storing processor-executable instructions. The instructions, when executed by the processor, cause the processor to: retrieve a first serialized data corresponding to a first user identifier in a non-relational database; deserialize the first serialized data to obtain a first index; perform a search based on the first index.

According to a third aspect of embodiments of the present disclosure, a non-transitory computer-readable storage medium having stored therein a computer program including instructions for executing the steps of the method for data search according to the first aspect of the present disclosure is provided.

It is to be understood that both the forgoing general description and the following detailed description are exemplary only, and are not restrictive of the present disclosure.

### BRIEF DESCRIPTION OF THE DRAWINGS

The accompanying drawings, which are incorporated herein and constitute a part of this specification, illustrate embodiments consistent with the invention and, together with the description, serve to explain the principles of the invention.

FIG. 1 is a flow diagram illustrating a method for data search according to an exemplary embodiment.

FIG. 2 is a flow diagram illustrating another method for data search according to an exemplary embodiment.

FIG. 3 is a diagram illustrating an application scenario for data search according to an exemplary embodiment.

FIG. 4 is a block diagram illustrating an apparatus for data search according to an exemplary embodiment.

FIG. 5 is a block diagram illustrating another apparatus for data search according to an exemplary embodiment.

FIG. 6 is a block diagram illustrating another apparatus for data search according to an exemplary embodiment.

FIG. 7 is a block diagram illustrating another apparatus for data search according to an exemplary embodiment.

FIG. 8 is a block diagram illustrating another apparatus for data search according to an exemplary embodiment.

FIG. 9 is a block diagram illustrating another apparatus for data search according to an exemplary embodiment.

FIG. 10 is a structural schematic diagram illustrating a device for data search according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of apparatuses and methods consistent with aspects related to the invention as recited in the appended claims.

The terms used in present disclosure are merely for describing the particular embodiments rather than limiting the present disclosure. Terms, such as “a”, “an”, “said”, and “the”, as used in singular form in present disclosure and appended claims include plural form, unless otherwise represent other meaning clearly in the context. It also should be understood that the term “and/or” used herein indicates and comprises any or all of possible combinations of one or more associated items which have been listed.

It should be understood that the terms “first,” “second,” and “third,” may be used to describe various information, but it not limit to these terms. These terms are only used to separate the same type of the information from each other. For example, the first information may also be referred as the second information without departing from the scope of the present disclosure, similarly the second information may also be referred as the first information. The word “if” as used herein may be interpreted as “when” or “while” or “respond to determination” depending on the context.

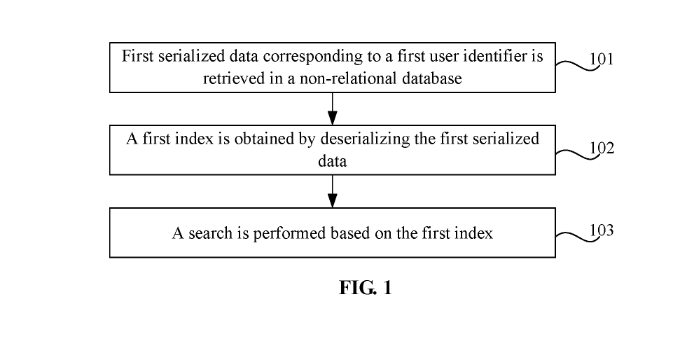

FIG. 1 is a flow diagram illustrating a method for data search according to an exemplary embodiment. As illustrated in FIG. 1, the method is used in a server, and may include the following steps.

In step 101, first serialized data corresponding to a first user identifier is retrieved in a non-relational database.

The server in the present disclosure may be cloud servers such as servers of Xiaomi Inc, and the like. The terminal device in the present disclosure may be any Internet-enabled smart terminal, for example, a mobile phone, a tablet computer, a personal digital assistant (Personal Digital Assistant, PDA) and the like. More particular, the terminal device may access a router via wireless LAN and then access a server in a public network through the router.

The non-relational database in the disclosure is a Non-relational Structured Query Language (NoSQL) database.

In step 102, a first index is obtained by deserializing the first serialized data.

Among them, serialization is a mechanism for supporting the streaming of user-defined types in .NET operating environment. Serialization is to save an object to a file or a database field, while deserialization is to translate the serialized file into the original object.

In step 103, a search is performed based on the first index.

It can be seen from the above embodiment that serialized data corresponding to a user identifier may be retrieved and deserialized into an index by a server in the NoSQL database and a search may be performed based on the index. Since the search is performed on data corresponding to user identifiers rather than data of all users, a much smaller search scope is covered, leading to an improved search speed and performance and optimized user experience.

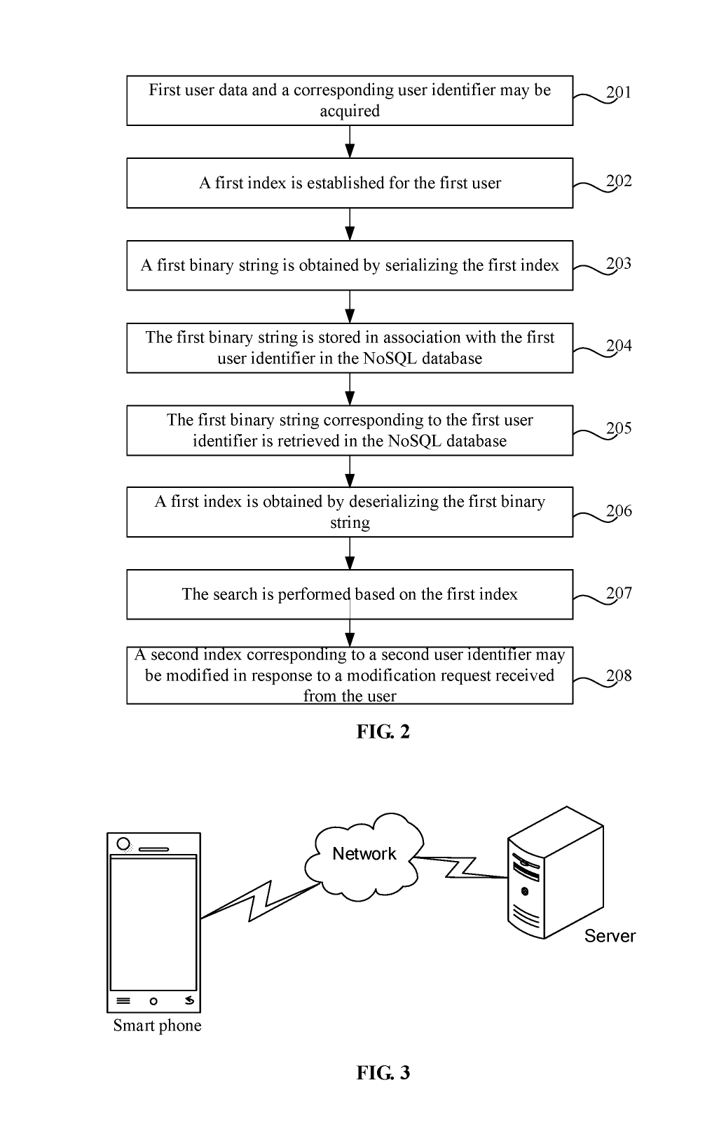

FIG. 2 is a flow diagram illustrating another method for data search according to an exemplary embodiment. As illustrated in FIG. 2, the method is used in a server, and may include the following steps.

In an embodiment of the disclosure, personal data of a user may be processed as a binary string and stored in a NoSQL database by a server.

In step 201, first user data and a corresponding user identifier may be acquired.

In this step of the disclosure, first user data uploaded by a first user may be received by the server. Alternatively, user data may be acquired by the server at set time intervals. The first user data may include personal data such as messages, contacts, e-mails, chat records and photographs of the first user. A first user identifier may also be received by the server in addition to the first user data. For example, the first user identifier received by servers of XiaoMi Inc. may be XiaoMi account information of the first user. Besides, a user identifier can also be a cell phone number of a user, a media access control (MAC) address of a terminal device, etc.

In step 202, a first index is established for the first user.

In this step of the disclosure, the first user data is initialized by the server and the first index is established for the first user via search engines such as Lucene. That is to say, indexes are established separately for different users by the server. The index may include a plurality of files such as an inverted list and a word list.

In step 203, a first binary string is obtained by serializing the first index.

In this step of the disclosure, the server serializes the first index (that is, an inverted list, a word list and various other files) into the first binary string such as an XML string, a JSON string, a binary stream and the like according to an underlying format of the index, for example, one name corresponding to one element. Generally, the binary string, for example, an index including thousands of messages or thousands of photographs, is relatively small or even no more than 2 Megabit and occupies a small storage space. Herein, serialization may be performed by methods employed in related arts, for example, XML Serialization, Binary Formatter, Soap Formatter and the like.

In step 204, the first binary string is stored in association with the first user identifier in the NoSQL database.

In this step of the disclosure, the server stores a user identifier and a binary string of each user in respective NoSQL database, for example, Casssandra, Lucene/Solr, BigTable/Accumulo/Hypertable and the like.

That is to say, in this step of the disclosure, the server stores binary strings of different users in different rows of the NoSQL database, and the binary string of each user is physically separated, thus contributing to the protection of user privacy and results in improved security. The server then performs a search based on the index stored in the NoSQL database upon receiving a search request from the user.

In step 205, the first binary string corresponding to the first user identifier is retrieved in the NoSQL database.

In this step of the disclosure, upon receiving the search request carrying a search criteria entered by the first user, the server may extract the first user identifier of the first user from the search request, and search and retrieve a corresponding first serialized data, wherein the first serialization data may be a binary string.

In step 206, a first index is obtained by deserializing the first binary string.

In this step of the disclosure, only deserialized files are readable to the server and can be used by the server to carry out the subsequent search step. Therefore, the server obtains the first index by deserializing the first binary string, i.e., the plurality of files corresponding to the personal data of the first user.

Since the NoSQL database is located on the disk of the server, the server may retrieve the first binary string from the disk into the memory for storage and then deserialize the first binary string in the memory to generate the first index.

In step 207, the search is performed based on the first index.

In this step of the disclosure, various search operations may be performed based on the search criteria and the first index when the first index is generated in the memory.

Because of the larger memory storage space and the smaller space occupied by the index of a single user, the index of the user is stored in the memory to be searched. Compared to searching in the disk with a huge amount of data, the retrieve speed of this method is greatly improved. Besides, since only retrieve operation is performed in the memory, occupied memory space will be released after the search is completed.

In related art, the server generates indexes for user data of all users and stores all of the indexes on the disk of the server, producing a huge amount of data (even as much as tens of Gigabit), resulting in slow speed to open the disk and thus the slow search speed and poor search performance, failing to meet the needs of the customer. In an embodiment of the disclosure, indexes are established separately for user data of different users and the binary string corresponding to each index is stored in association with the user identifier, thus when a search for a user's data is needed, a search for a corresponding index may be performed simply based on the user identifier, narrowing greatly the search scope and at the same time improving significantly the search speed.

In an embodiment of the disclosure, when new user data is uploaded by a user or user data is modified or deleted, the server need to modify the index. In this case, the embodiment of the disclosure may further include the following step.

In step 208, a second index corresponding to a second user identifier may be modified in response to a modification request received from the user.

In this step of the disclosure, the server acquires the second user identifier in the modification request, retrieves a corresponding second binary string according to the second user identifier, and then retrieves the second binary string from the disk into the memory and deserializes the second binary string to obtain a second index corresponding to the second user identifier, and then modifies the second index based on the modification request in the memory, at last serializes the modified second index into a binary string and stores the binary string in the NoSQL database, that is to say, the second binary string stored in the NoSQL database is updated to the binary string corresponding to the modified second index.

In the abovementioned embodiment of the disclosure, since the index of each user is independent, the search scope is better targeted and the search performance is guaranteed. Therefore, the number of the users whose data may be stored by a server depends on the storage size of the NoSQL. For example, if the size of the index of each user is 2 Mb, and the size of the disk space of a server is 100 Gigabit, then about 100 G/2M=50 thousand users may be served by the server. If a search method based on pure search such as Lucene employed in the related art is utilized, in which indexes for the 50 thousand users may be stored in the 100 Gb disk space, the search may be performed on data of all users, thus resulting in poor search performance and long search latency. In order to ensure search performance, the amount of user data stored in the server may need to be reduced, making it impossible to store data of 50 thousand users, in fact, perhaps only data of 10 thousand users may be stored. The search scope of the disclosure is not performed on data of all users, so the search performance thereof may be improved. For a single server, the scheme proposed in the disclosure is capable of storing data of more user, therefore the scheme proposed in the disclosure needs less servers than the related art.

FIG. 3 is a diagram illustrating an application scenario for data search according to an exemplary embodiment. As illustrated in FIG. 3, a server and a smart phone are included in the scenario.

The server receives from a user of the smart phone a search request carrying a search criteria and a user identifier of the user, retrieves a binary string corresponding to the user identifier from the NoSQL database based on the user identifier, then deserializes the retrieved binary string to obtain an index corresponding to the user identifier, and saves the index into the memory and performs a search based on the index and the search criteria.

In the scenario illustrated in FIG. 3, descriptions for FIG. 1 and FIG. 2 may be referred to for the process of carrying out data search, which is not repeated herein.

Corresponding to embodiments of methods for data search, embodiments of devices for data search and servers used therein are also provided herein.

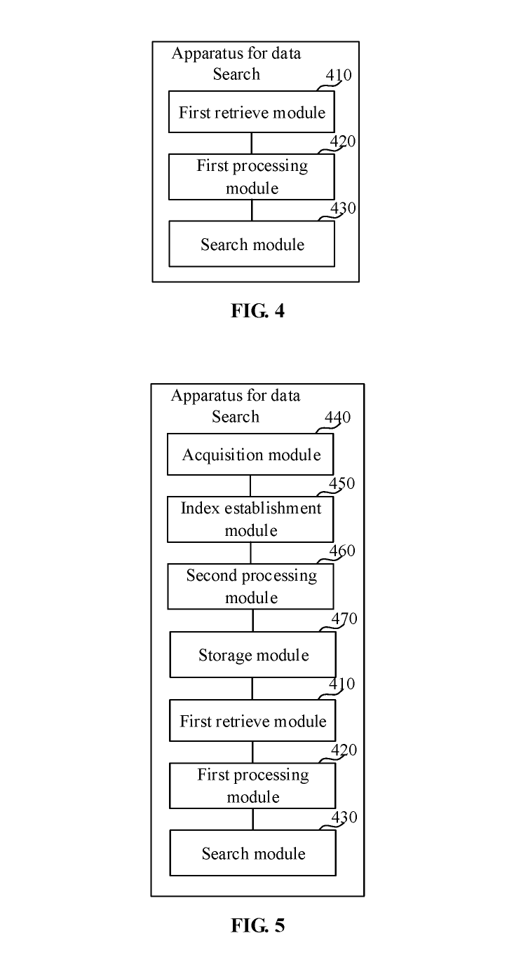

FIG. 4 is a block diagram illustrating an apparatus for data search according to an exemplary embodiment. The apparatus may include a first retrieve module 410, a first processing module 420, and search module 430.

Among them, the first retrieve module 410 is configured to retrieve a first serialized data corresponding to a first user identifier in a NoSQL database; the first processing module 420 is configured to obtain a first index by deserializing the first serialized data retrieved by the first retrieve module 410; the search module 430 is configured to perform a search based on the first index obtained by the first processing module 420.

In the abovementioned embodiment, the server may retrieve serialized data corresponding to a user identifier in a NoSQL database, deserialize the serialized data into an index and perform a search based on the index. Since the search is performed on data corresponding to user identifiers rather than all users, a much smaller search scope is covered, leading to an improved search speed and performance and optimized user experience.

FIG. 5 is a block diagram illustrating another apparatus for data search according to an exemplary embodiment. In addition to the modules illustrated in FIG. 4, the apparatus may further include an acquisition module 440, an index establishment module 450, a second processing module 460 and a storage module 470.

Among them, the acquisition module 440 is configured to acquire first user data and a corresponding first user identifier.

The index establishment module 450 is configured to establish an index for the first user data acquired by the acquisition module 440.

The second processing module 460 is configured to serialize the index established by the index establishment module 450 to obtain a binary string.

The storage module 470 is configured to store the binary string obtained by the second processing module 460 in association with the first user identifier in the NoSQL database, wherein the first serialized data includes the binary string.

In the abovementioned embodiment, a server establishes indexes separately for different users and serializes the indexes separately into binary strings, and then stores the binary strings and corresponding user identifiers in a NoSQL database for different users, thus time efficiency and consistency of a search may be guaranteed due to better time efficiency and consistency owned by the NoSQL database itself. Besides, since user data is stored in different rows of the NoSQL database, the search is carried out on data corresponding to user identifiers, thereby contributing to the protection of user privacy and resulting in improved security. Moreover, search security may be further ensured due to the fact that the NoSQL database may backup a plurality of copies underlying and automatically. In addition, compared to the pure search scheme, less servers may be needed when the number of users increases due to the storage characteristic of the NoSQL database itself.

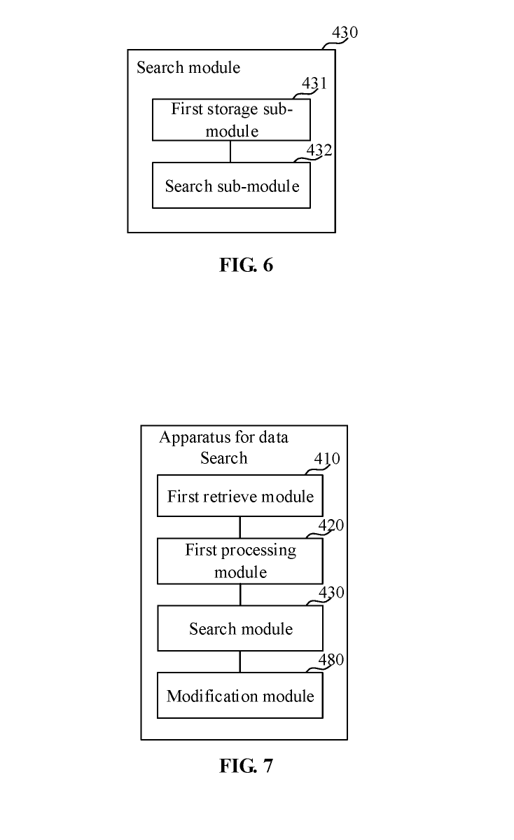

FIG. 6 is a block diagram illustrating another apparatus for data search according to an exemplary embodiment. In addition to the embodiment illustrated in FIG. 4, the search module 430 may include a first storage sub-module 431 and a search sub-module 432.

Among them, the first storage sub-module 431 is configured to store a first index in the memory; the search sub-module 432 is configured to perform a search in the memory based on the first index stored by the first storage sub-module 431.

In the abovementioned embodiment, a first index may be stored in the memory and a search may be performed in the memory based on the first index. Retrieve speed may be greatly improved for the search performed in the memory compared to the search performed in a disk that has a huge amount of data.

FIG. 7 is a block diagram illustrating another apparatus for data search according to an exemplary embodiment. In addition to the embodiment illustrated in FIG. 4, the apparatus may further include a modification module 480.

Among them, the modification module 480 is configured to modify a second index corresponding to a second user identifier in response to receiving a modification request, wherein the modification request contains the second user identifier.

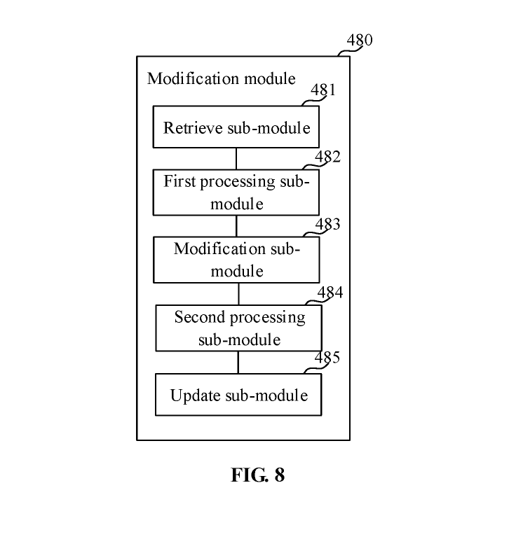

FIG. 8 is a block diagram illustrating another apparatus for data search according to an exemplary embodiment. In addition to the embodiment illustrated in FIG. 7, the modification module 480 may include a retrieve sub-module 481, a first processing sub-module 482, a modification sub-module 483, a second processing sub-module 484 and a update sub-module 485.

Among them, the retrieve sub-module 481 is configured to retrieve a second serialized data corresponding to a second user identifier in a NoSQL database.

The first processing sub-module 482 is configured to deserialize the second serialized data retrieved by the retrieve sub-module 481 to obtain a second index.

The modification sub-module 483 is configured to modify the second index obtained by the first processing sub-module 482 based on the modification request.

The second processing sub-module 484 is configured to serialize the second index modified by the modification sub-module 483 to obtain a second serialized data that has been modified.

The update sub-module 485 is configured to update the second serialized data stored in the NoSQL database to the second serialized data that has been modified

In the abovementioned embodiment, a server may also modify an index, deserialize a binary string corresponding to a user identifier into an index, modify the index, serialize the modified index into a binary string, and update the binary string stored in a NoSQL database. Thus the time efficiency of a search may be guaranteed by updating the data stored in the NoSQL database timely in the case that there is a need to add, delete or modify user data.

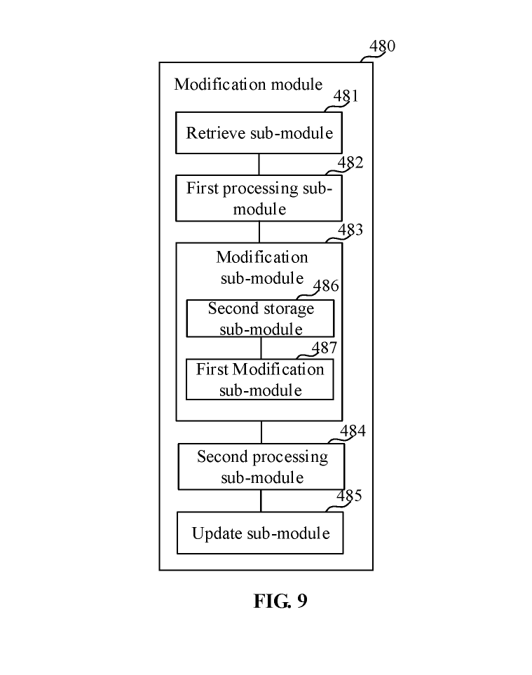

FIG. 9 is a block diagram illustrating another apparatus for data search according to an exemplary embodiment. In addition to the modules illustrated in FIG. 8, the apparatus may further include a second storage sub-module 486 and a first modification sub-module 487.

Among them, the second storage sub-module 486 is configured to store a second index in the memory.

The first modification sub-module 487 is configured to modify the second index stored by the second storage sub-module 486 in the memory.

In the abovementioned embodiment, modification to user data may also be performed in the memory to improve speed and performance of a search.

Description of a corresponding step of a method may be referred to for the details of the process in which function and effect of respective module are realized.

For embodiments of an apparatus, since it substantially corresponds to embodiments of a method, description of a certain part of the method may be referred to for description of a relevant part of the apparatus. The above-described embodiments of an apparatus are for illustrative purposes only, wherein elements described as separate components may or may not be physically separated, and components illustrated as elements may or may not be physical elements (i.e., these components may be located in the same place, or be distributed in several network elements). Part or all of the modules may be selected to realize the purposes of the scheme of this disclosure according to actual needs. Those of ordinary skill in the art may be able to understand and practice the scheme without creative efforts.

Accordingly, a server is provided in the disclosure, the server comprising: a processor; a memory for storing processor-executable instructions; wherein the processor is configured to: retrieve a first serialized data corresponding to a first user identifier in a non-relational database; obtain a first index by deserializing the first serialized data; perform a search based on the first index.

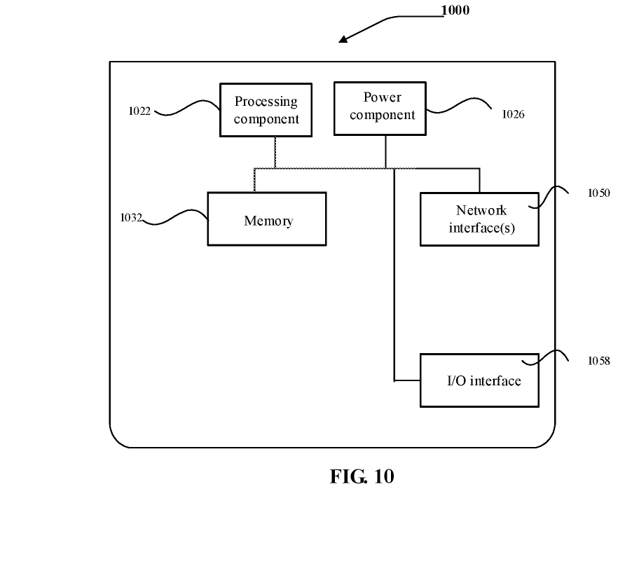

FIG. 10 is a structural schematic diagram illustrating a device 1000 for data search according to an exemplary embodiment. For example, the device 1000 may be a server. The device 1000 may include a processing component 1022 (e.g. one or more processors), and storage resources such as a memory 1932 for storing processing component 1022 executable instructions such as applications programs. The application programs stored in the memory 1932 may include one or more modules (not shown). Each module may include a set of instructions for operations on the device 1000. Further, the processing component 1022 may be configured to 0execute the sets of instructions and perform the operations on the device 1000.

The device 1000 may also include a power supply 1026 configured to perform power management for the device 1000, a wired or wireless network interfaces 1050 configured to connect the device 1000 to network, and/or an input/output interfaces 1058. The device 1000 may operate an operating systems stored in the memory 1032, such as Windows Server™, Mac OS X™, Unix™, Linux™, FreeBSD™, or the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for data search, comprising:
retrieving a first serialized data corresponding to a first user identifier in a non-relational database;
deserializing the first serialized data to obtain a first index; and
performing a search based on the first index.

2. The method of claim 1, wherein before retrieving the first serialized data corresponding to the first user identifier in the non-relational database, the method further comprises:
acquiring a first user data and a corresponding first user identifier;
establishing a first index for the first user data;
serializing the first index to obtain a first binary string; and
storing the first binary string, in association with the first user identifier, in the non-relational database, wherein the first serialized data includes the first binary string.

3. The method of claim 1, wherein performing a search based on the first index comprises:
storing the first index in a memory; and
performing the search in the memory based on the first index.

4. The method of claim 1, wherein the method further comprises:
modifying a second index corresponding to a second user identifier in response to receiving a modification request including the second user identifier.

5. The method of claim 4, wherein modifying the second index corresponding to the second user identifier in response to receiving the modification request including the second user identifier comprises:
retrieving a second serialized data corresponding to the second user identifier in the non-rational database;
deserializing the second serialized data to obtain the second index;
modifying the second index based on the modification request;
serializing the modified second index to obtain a modified second serialized data; and
updating the second serialized data stored in the non-rational database to the modified second serialized data.

6. The method of claim 5, wherein modifying the second index based on the modification request comprises:
storing the second index in a memory; and
modifying the second index in the memory.

7. A device for data search, comprising:
a processor; and
a memory for storing processor-executable instructions;
wherein the instructions, when executed by the processor, cause the processor to:
retrieve a first serialized data corresponding to a first user identifier in a non-relational database;
deserialize the first serialized data to obtain a first index; and
perform a search based on the first index.

8. The device of claim 7, wherein the instructions, when executed by the processor, further cause the processor to:
acquire a first user data and a corresponding first user identifier;
establish a first index for the first user data;
serialize the first index to obtain a first binary string; and
store the first binary string, in association with the first user identifier, in the non-relational database, wherein the first serialized data includes the first binary string.

9. The device of claim 7, wherein the instructions, when executed by the processor, further cause the processor to:
store the first index in a memory; and
perform the search in the memory based on the first index.

10. The device of claim 7, wherein the instructions, when executed by the processor, further cause the processor to:
modify a second index corresponding to a second user identifier in response to receiving a modification request including the second user identifier.

11. The device of claim 10, wherein the instructions, when executed by the processor, further cause the processor to:
retrieve a second serialized data corresponding to the second user identifier in the non-rational database;
deserialize the second serialized data to obtain the second index;
modify the second index based on the modification request;
serialize the modified second index to obtain a modified second serialized data; and
update the second serialized data stored in the non-rational database to the modified second serialized data.

12. The device of claim 11, wherein the instructions, when executed by the processor, further cause the processor to:
store the second index in a memory; and
modify the second index in the memory.

13. A non-transitory computer-readable storage medium having stored therein a computer program including instructions for executing the steps of a method for data search according to claim 1.
